(19) United States
(12) Patent Application Publication
(10) Pub. No.: US 2025/0264119 A1
(43) Pub. Date: Aug. 21, 2025

(54) WELD-COUPLED WORKING CYLINDER ASSEMBLY AND METHOD FOR PRODUCING SAME

(71) Applicant: BÜMACH ENGINEERING INTERNATIONAL B. V., TA Emmen (NL)

(72) Inventor: Josef BUETER, Haren/Altenberge (DE)

(21) Appl. No.: 18/865,699

(22) PCT Filed: Apr. 28, 2023
(86) PCT No.: PCT/DE2023/000027

§ 371 Date: Nov. 14, 2024

(30) Foreign Application Priority Data
May 25, 2022 (DE) 10 2022 001 843.8

(51) Int. Cl. F15B 15/14; B23K 26/28

(52) U.S. Cl. CPC F15B 15/1428; B23K 26/28

(57) ABSTRACT

A working cylinder assembly has a cylinder component, an attachment part and a weld seam. The weld seam is a stepped hybrid weld seam, which has a lower weld seam zone and an upper weld seam zone. In the lower weld seam zone, the cylinder component has a lower cylinder component seam surface and the attachment part has a lower attachment part seam surface. The lower seam surfaces have a butt joint and the lower weld seam zone is a laser weld seam. In the upper weld seam zone, the cylinder component has an upper cylinder component seam surface and the attachment part has an upper attachment part seam surface. The upper weld seam zone is a laser hybrid weld seam with a welding filler material in an upper weld seam space defined by the surface separation (5.3) between the upper seam surfaces (5.1, 5.2).

The invention relates to a weld-coupled working cylinder assembly and a method for producing such a working cylinder assembly, in particular for hydraulic working cylinders with high actuating forces.

It is known from the prior art to provide hydraulic working cylinders with attachment parts for transmitting the actuating forces generated by the working cylinder to the devices to be actuated. Such attachment parts may be so-called rod-eyes, in particular.

Furthermore, it is known from the state of the art to weld on such attachment parts. Since very high forces have to be absorbed here, as intended, via the welded connection, in larger hydraulic cylinders, the weld seams, which are produced as MAG weld seams, for example, must have a large weld seam surface and thus a large weld seam depth.

The disadvantage of such designs is that, on the one hand, a high heat input is necessary, which brings about the risk of scaling in the working cylinder, thermal distortion or damage to components that are less resistant to thermal stress, such as seals or guides. Moreover, a high consumption of welding wire and energy can be observed as a further disadvantage.

It is also known from the prior art to produce laser welded joints, for which very high laser powers have to be used for the required weld depths so that laser welding is disadvantageously very expensive and uneconomical.

The task of the invention is to provide a welded working cylinder assembly that can withstand very high loads and can be produced in a resource-saving and economical manner. Furthermore, the task of the invention is to provide a reliable and at the same time economical method for producing such a working cylinder assembly.

Concerning the working cylinder assembly, the task is solved by the features described in claim 1 and, concerning the production process, by the features claimed in claim 5. Preferred further embodiments result from the respective sub-claims.

The basic components of the weld-coupled working cylinder assembly according to the invention are a working cylinder component, an attachment part and a weld seam.

The working cylinder component is designed as a piston rod or as a closure part in a manner known per se. In the context of the present invention, working cylinders are understood to be linear pressure-flow consumers in which a pressure medium acts on a piston surface and thus provides an actuating force that can be a thrust force or a pressure force. Preferably, the working cylinder is a hydraulic working cylinder. It can be designed, for example, as a differential working cylinder, pull cylinder, double rod cylinder or plunger cylinder.

The working cylinder component is the component of the working cylinder from which the actuating force is taken. In particular, this can be a closure part such as a bottom closure part. Furthermore, it can be a piston unit, in particular a piston rod, wherein the outer section of a plunger piston is also understood to be a piston rod.

The attachment part is a coupling module designed to be coupled to a device to be actuated in order to transmit force. When the working cylinder is used as intended, the coupling module is connected to a device to be actuated, usually in the form of a hinged connection, for which the coupling module is designed as a joint bearing, also referred to as a rod-eye or joint head. However, the coupling module can also be designed in a different way.

Hereinafter, the working cylinder component and the attachment part are also referred to collectively as the coupling partners.

Furthermore, the weld-coupled working cylinder assembly according to the invention has a weld seam that connects the working cylinder component and the attachment part in a positive-substance manner.

This weld seam is structured in a special way according to the invention and is characterized in that it is formed as a step-wise hybrid weld seam produced in steps.

For this design, the weld seam has a lower weld seam zone and an upper weld seam zone. The position indications of lower weld seam and upper weld seam zones are to be understood independently of the position in space. In relation to a weld seam depth, the lower weld seam zone refers to the section facing away from the component surface and the direction of attack of the welding materials, and the upper weld seam zone refers to the section relative to a weld depth that connects to the component surface, covers the lower weld seam zone and faces the direction of attack of the welding materials.

In the lower weld seam zone, the working cylinder component has a lower working cylinder component weld seam surface and the attachment part has a lower attachment part weld seam surface. Hereinafter, the lower working cylinder component weld seam surface and the lower attachment part weld seam surface are also referred to, in a summarized manner, as the lower weld seam surfaces.

According to the invention, the lower weld seam surfaces have a butt joint to each other which is joined in a positive-substance manner by a laser weld seam. The laser weld seam is flush and produced without a gap, and welding is done without a welding filler metal.

In the upper weld seam zone, the working cylinder component and the attachment part also have identically shaped weld seam surfaces that are at a certain distance from each other, and the space formed between them is referred to as the weld seam space. This arrangement allows the laser beam to pass through and thus enables laser welding in the lower weld seam zone.

In this case, the working cylinder component has an upper working cylinder component weld seam surface and the attachment part has an upper attachment part weld seam surface. Hereinafter, the upper working cylinder component weld seam surface and the upper attachment part weld seam surface are also referred to collectively as the upper weld seam surfaces. The lower and upper weld seam surfaces are also collectively referred to as the seam surfaces.

The upper weld seam surfaces have a separation (distance) from each other.

This means that the upper weld seam surfaces are essentially arranged in a plane-parallel and spaced manner. The thus formed space between the upper weld seam surfaces is referred to as the upper weld seam space. The upper weld seam space is arranged in such a way that it provides a free cross-section for a laser beam for the production of the laser weld seam of the lower weld seam zone.

The upper weld seam zone is formed as a laser hybrid weld seam under these design conditions and represents an essential part of the solution according to the invention, since the laser beam simultaneously takes over melting of the preferably ca. 0.8 mm thick welding electrode here. Thus, the upper weld seam zone has a filling of welding filler material that fills the upper weld seam space and thus indirectly joins the upper weld seam surfaces to one another in a positive-substance manner. The laser hybrid weld seam of the upper weld seam zone is provided as a so-called I-weld seam, which, according to the invention, has a greater width than the laser weld seam of the lower weld seam zone.

Thus, the upper weld seam space advantageously fulfils two functions at the same time, which are essential for the solution according to the invention. It enables unhindered access of the laser beam to the lower weld seam zone. It provides the space that is required to receive the welding filler material.

The welding filler material is preferably the material of a welding wire. The welding means of the upper weld seam zone is also a laser beam. In this case, the laser beam in the upper weld seam zone is applied subsequently to the laser beam of the lower weld seam zone. Preferably, it is the same laser beam that is applied subsequently to the lower weld seam zone and now strikes the welding filler material in the upper weld seam space. This can be realized in a particularly advantageous manner for rotationally symmetrical welding partners because the lower and upper weld seams can be produced in succession. In the first rotation, the lower weld seam is produced and in the second rotation, the welding filler material is melted and at the same time the free space between the welding partners involved is filled in the upper weld seam space.

The coupling provided according to the invention can also be referred to as a laser-laser hybrid coupling or as a step-wise produced hybrid welding. It has the following advantages in particular.

The butt joint of the lower weld seam zone achieves a particularly precise positioning because this weld seam surface keeps the welding partners in position without distortion during the immediately following cooling process. A further advantage is the increased energy efficiency since the solidification heat released from the lower weld seam zone acts as a preheating of the upper weld seam zone. Furthermore, it is advantageous from the production point of view that the separation of the total weld seam into the two weld seam zones makes it possible to apply a lower laser power so that lower-power laser welding systems can be used, which has a very favourable effect on investment costs. The application of laser hybrid welding coupling allows to use all known laser beam generation technologies, such as YAG lasers and CO2 lasers, and is not restricted to a specific type of laser generation. Another advantage from the technological perspective is the high processing speed at which the seams can be produced, which means that expensive and time-intensive processes such as friction welding, prefabricated forgings, are not required at all. Finally, the quality of the welded joint is increased by the reduction of heat in the welding process in that scaling can be completely excluded and, as a result of this heat reduction, sensitive elements of the working cylinder are protected.

In addition, the following applies in in detail.

A coupling with a particularly high quality is provided. The butt joint of the lower weld seam zone enables a particularly precise positioning of the coupling partners relative to each other. A surprising solution was found to reliably maintain this precise positional relationship during and until the completion of the welding process and to initially requiring a very low energy input per unit length in the lower weld seam zone, thus minimizing a thermal distortion. This possible low energy input per unit length is based, on the one hand, on the laser welding technology, but on the other hand, it is also based on the reduction of the total weld seam depth, first to the lower weld seam zone depth. In addition, the energy input per unit length has a direct effect only on the lower weld seam zone so that the initially still cold material body in the area of the upper weld seam zone supports the material body of the lower weld seam zone and additionally counteracts its thermal deformation. In this context, there is also the advantage that the creation of the upper weld seam space provides the direct access of the laser beam to the lower weld seam zone without additional efforts.

Furthermore, the laser beam creates only a very narrow melting zone in the lower weld seam zone with correspondingly little thermal energy input being required. This can be removed very quickly from the lower weld seam surfaces into the material of the coupling partners so that solidification occurs quickly in the lower weld seam zone. This means that the coupling partners are already fixed in their position in a positive-substance manner when the longer cooling and solidification phase begins in the upper weld seam zone due to the wider weld seam and the higher heat input, thus counteracting thermal distortion caused by the upper weld seam zone.

Another advantage is the increased energy efficiency. The heat of solidification released in the lower weld seam zone due to the solidification of the melting zone is dissipated into the material of the coupling partners and provides preheating for the weld seam in the upper weld seam zone so that the energy input per unit length to be applied there can be reduced by this amount. This has the particular advantage that the upper weld seam zone is heated from below so that rapid melting and thermal homogenization in the upper weld seam zone is achieved then by the heat input of the laser beam during its second application from above.

Furthermore, it is advantageous from the technological point of view that both the lower laser weld seam and the upper laser hybrid weld seam require a lower laser power than laser welding of the entire weld seam would need. Therefore, low-cost laser welding systems with a lower power of about 5 to 10 KW can also be used to provide the weld-coupled working cylinder assembly according to the invention for the production of medium-sized hydraulic working cylinder assemblies, and the investment costs can be significantly reduced.

In addition, a welding filler material such as welding wire is only required for the upper weld seam zone so that material and costs can be saved here.

Advantageously, the weld seam can be formed both perpendicularly and at an angle.

Finally, by reducing the heating of the working cylinder component, the quality is increased by avoiding scaling or damage to thermally sensitive elements.

According to claim 2 and according to another aspect of the invention, the working cylinder component is a cylinder tube and the attachment part is a closure part or a further closure part. This one can be either the closure part—designed as a bottom closure part in particular—welded to a coupling module according to the invention, or it can be another closure part that is not welded to a coupling module according to the invention. In particular, it may also be a guide closure part. A closure part or a further closure part in the sense of this further aspect of the invention is hereinafter referred to in short as a closure part.

Thus, the weld seam according to this further aspect of the invention couples the cylinder tube to the closure part. In this design, the upper weld seam zone is formed as an outer ring surface and the lower weld seam zone as an inner ring surface. And, the descriptive content relating to the weld seam of a welded coupling between a piston rod or a closure part to a coupling module also applies in a corresponding manner to a weld seam of a welded coupling between the cylinder tube and a closure part.

This aspect of the invention is particularly advantageous in the case of a welded coupling according to the invention in heavy hydraulic cylinders. Heavy hydraulic cylinders are understood to be hydraulic cylinders with a cylinder tube wall thickness of 10 mm or more, preferably of 15 mm or more. Here, the preferred cylinder tube inner diameters are 100 mm or more, preferably 150 mm or more.

The manufacturing advantages, in particular the savings in cost-intensive welding filler materials, the reduction in costs for the laser and the improvement in precision, are considerably significant for heavy hydraulic cylinders.

According to an advantageous further development, the weld-coupled working cylinder assembly is characterized in that a lower weld seam zone surface and an upper weld seam zone surface form a total weld seam zone surface and that the surface ratio of the lower weld seam zone surface to the total weld seam zone surface is 15% to 40%. In a particularly preferred design, this surface ratio is 20% to 30%. It has been experimentally demonstrated that the weld seam can be produced extremely precisely and without distortion at this ratio. Rapid solidification of the melting zone in the lower weld seam zone is achieved.

The weld seam surfaces are rotationally symmetrical geometries, in particular in the case of a weld coupling at a piston rod. When completely welded, the lower weld seam zone of rotationally symmetrical parts is an inner circular surface and the upper weld seam zone is a ring surface that radially encloses the lower weld seam zone. The inner circular surface of the lower weld seam zone and the outer ring surface of the upper weld seam zone form together a total circular surface that forms the total weld seam zone surface; thus both surfaces form the total weld seam. The surface ratio of the inner circular surface to the total circular surface is, according to this further development, 15% to 40%, and in a particularly preferred design, 20% to 30%. It is an advantage that the two zones to be welded can be welded in only one clamping by two successive rotations.

According to a further advantageous development, the weld-coupled working cylinder assembly is characterized in that the surface separation in the upper weld seam zone is 0.5 mm to 2.0 mm. In a particularly preferred design, the surface separation is 1.0 mm to 1.5 mm.

It was found that, on the one hand, this surface separation advantageously allows good penetration of the laser beam into the lower weld seam zone, and, on the other hand, it allows a low consumption of welding filler material, such as weld wire in particular, and a comparatively low energy input per unit length in the upper weld seam zone with a simultaneously reliable welding in the upper weld seam zone, too.

According to a further advantageous development, the weld-coupled working cylinder assembly is characterized in that the lower weld seam zone surface is formed as an inner circular surface or as an inner ring surface and that the upper weld seam zone surface is formed as an outer ring surface which radially encloses the lower weld seam zone surface. Both partial surfaces together form the total weld seam zone surface, which can then be either a total circular surface or a total ring surface.

This further development is advantageous both in that the heat dissipation after the production of the laser weld seam of the lower weld seam zone is lower towards the bottom than towards the top due to the radial geometry. This fact additionally improves the preheating of the upper weld seam zone. At the same time, this further development is advantageous from a technological point of view since the lower weld seam zone and the upper weld seam zone can be realized sequentially and in a single clamping by two successive rotations of the pre- positioned coupling partners under the laser beam.

According to another aspect of the invention, a method for producing a weld-coupled working cylinder assembly is provided, wherein the working cylinder component is designed as a piston rod or as a closure part, and wherein the attachment part is designed as a coupling module. The coupling module is designed to be coupled to a device to be actuated for the transmission of force.

The method comprises the following process steps:
a) providing the working cylinder component and the attachment part,
b) producing the weld seam surfaces to be connected, i.e., producing a lower working cylinder component weld seam surface and a lower attachment part weld seam surface as well as an upper working cylinder component weld seam surface and an upper attachment part weld seam surface, wherein at least one of the upper weld seam surfaces is set back relative to the respective lower weld seam surface,
c) positioning the working cylinder component and the attachment part to form a pre-assembly by producing a butt joint of the lower weld seam surfaces and creating a surface separation of the upper weld seam surfaces,
d) laser welding of the lower weld seam surfaces by means of a laser beam by producing a laser weld seam in the lower weld seam zone,
e) laser hybrid welding of the upper weld seam surfaces by means of the laser beam and supply of a welding filler material, melting the welding filler material by means of the same laser beam and filling an upper weld seam space between the upper weld seam surfaces.

The description contents for the weld-coupled working cylinder assembly and the definitions of terms used there also apply in a corresponding manner to the method for their production.

In process step a), the working cylinder component and the attachment part are provided. The production of these two coupling parts is carried out in a manner known per se.

In process step b), a lower working cylinder component weld seam surface and a lower attachment part weld seam surface as well as an upper working cylinder component weld seam surface and an upper attachment part weld seam surface are produced, with at least one of the upper weld seam surfaces being set back relative to the respective lower weld seam surface.

Since the seam surfaces are usually rotationally symmetrical component sections, they are preferably produced by turning or milling. The lower weld seam surfaces, in particular, have preferably an exactly planar design. In the case of a symmetrical design, the set-back of the upper weld seam surfaces is half the later desired surface separation. However, an asymmetrical distribution of the set-backs is also possible. In addition, in special cases, one coupling partner can be provided with seam surfaces that are free of set-backs relative to each other and only the other coupling partner is provided with a set-back so that then this set-back alone provides the surface separation.

In process step c), the positioning of the working cylinder component and the attachment part to form a pre-assembly is carried out by producing a butt joint of the lower weld seam surfaces and a surface separation of the upper weld seam surfaces.

1 For this purpose, the coupling partners are preferably pressed axially against each other so that the lower weld seam surfaces are in pressure contact with each other. Here, the two coupling partners are also aligned along a longitudinal axis corresponding to the desired later position of the attachment parts relative to the longitudinal axis of the working cylinder assembly. The positional relationship established in this way is then maintained during the further process steps, preferably until they are completed.

In process step d), the lower weld seam surfaces are laser welded by means of a laser beam by producing the laser weld seam in the lower weld seam zone.

According to the invention, an upper weld seam space, which is created by the surface separation of the upper weld seam surfaces, provides an unobstructed access for the laser beam up to the upper beginning of the lower weld seam zone. Preferably, the laser beam penetrates exactly into the planar surface defined by the butt joint of the lower weld seam surfaces and melts the seam surfaces at their surficial areas so that a thin planar melt is provided, which, after solidification, joins the coupling partners at the lower weld seam surfaces in a positive-substance manner and forms the laser weld seam. In process step d), 18 the laser weld seam is produced without the addition of a welding filler material.

According to the invention, the heat of solidification is at least partially dissipated upwards into the upper weld seam zone in this process. This has the advantage of both heating the upper weld seam zone and drawing off the energy per unit length which has been input into the lower weld seam zone, thus avoiding an undesirably strong heating in the surrounding area of the lower weld seam zone.

In process step e), the laser hybrid welding of the upper weld seam surfaces is carried out. The upper weld seam surfaces are welded by laser hybrid welding by means of the laser beam and the supply of welding filler material and filling of an upper weld seam space between the upper weld seam surfaces.

In the upper weld seam zone, which has already been preheated in process step d), the upper weld seam surfaces are further heated until they begin to melt by the renewed application of a laser beam. According to the invention, welding filler material is added, preferably via a welding wire, is melted, forms part of the melt of the upper weld seam zone and fills the upper weld seam space existing between the upper weld seam surfaces and is thus directly connected to the upper weld seam surfaces.

After the upper weld seam space has been filled with the melt, the application of the laser beam is finished and the upper weld seam zone cools then, causing the melt in the upper weld seam space to solidify and an indirect positive-substance joint to be formed between the upper weld seam surfaces, thus creating the hybrid weld. The indirect positive-substance connection is based on the fact that the positive-substance connection between the upper weld seam surfaces is mediated by the solidified melt with the involvement of the welding filler material.

As a result of carrying out all the process steps, the weld-coupled working cylinder assembly, which exhibits a laser-laser hybrid weld seam according to the invention, is obtained.

The invention also covers the case in which process step e) is carried out repeatedly, thus filling the upper weld seam space layer by layer with the welding filler material.

The advantages described for the weld-coupled working cylinder assembly according to the invention apply correspondingly to the method. In particular, it is advantageous that, due to the low energy input per unit length and the very narrow melting zone at the lower weld seam surfaces, solidification occurs in process step d) when the upper weld seam zone, with its wider melting zone caused by the surface separation between the upper weld seam surfaces, has not yet solidified in the upper weld seam space. Thus, a connection between the coupling partners is already created which determines their positional relationship and protects them against distortion due to the subsequent solidification of the upper weld seam zone. The same advantages, which have been described due to the importance of using laser welding systems with lower power, are simultaneously achieved in the method.

The laser hybrid weld seam of the upper weld seam zone is produced with a time delay of preferably 2 to a maximum of 10 seconds-referred to always one point-before the laser weld seam of the lower weld seam zone is produced.

Furthermore, increased bending stiffness is achieved without additional measures at the weld seam for rotationally symmetrical components, i.e., if an upper weld seam surface is provided as an outer circular ring surface. This positive aspect is based on the fact that the lower laser weld seam has already solidified and shrunk thermally when the upper laser hybrid weld seam is produced. The subsequent thermal shrinkage of the upper hybrid weld seam causes an elastic pre-stress in the upper weld seam zone surface, which is an outer circular ring surface here. This is supported by the fact that the upper weld seam zone is wider than the lower weld seam zone, provided with a butt joint, due to the surface separation of the upper weld seam surfaces, and thus the thermal shrinkage of the upper weld seam zone is stronger than that of the lower weld seam zone. The degree of pre-stress can be advantageously adjusted as required by means of both the surface ratio of the lower weld seam zone surface and the upper weld seam zone surface and by means of the surface separation of the upper weld seam surfaces, and thus an assembly of a working cylinder component and an attachment part with improved mechanical properties can be obtained.

According to a further advantageous development, the method for producing a weld-coupled working cylinder assembly is characterized in that an energy input per unit length applied in process step d) in the lower weld seam zone is lower relative to a lower weld seam zone surface than an energy input per unit length applied in process step e) in the upper weld seam zone relative to an upper weld seam zone surface.

Advantageously, the lower energy input per unit length, relative to the weld seam zone surface, in the lower weld seam zone in process step d) compared to the energy input per unit length in the upper weld seam zone in process step e) ensures that solidification occurs earlier in the lower weld seam zone than in the upper weld seam zone and the positional relationship of the coupling partners is already stabilized when distortion forces act on the coupling partners due to the solidification of the upper weld seam zone.

According to a next advantageous development, the method for producing a weld-coupled working cylinder assembly is characterized in that an energy input per unit length in process step d) in the lower weld seam zone simultaneously meets the requirements of the melting of the welding filler material for the upper weld seam zone. Thus, welding of each of the two weld seam zones can be performed with the same laser power and at the same speed.

According to a further development, the method for producing a weld-coupled working cylinder assembly is characterized in that the lower weld seam surfaces are designed as an inner circular surface or an inner ring surface, in that the upper weld seam surfaces are designed as an outer ring surface which radially encloses the inner circular surface or inner ring surface, and that in process step d) a movement of the pre-assembly relative to the laser is carried out by means of a rotation of the pre-assembly, and that in process step e) a movement of the pre-assembly relative to the laser is carried out by means of a further rotation of the pre-assembly.

The advantages of the method according to the invention are particularly effective for the rotationally symmetrical coupling sections of the working cylinder component and the attachment part. After the coupling partners have been joined to the pre-assembly and fixed in their relative position, they can be guided and welded by rotation under the laser so that the laser can be applied in a reliable, uniform manner. Thus, the laser weld seam is produced by the first rotation according to process step d). After the completion of a 360-degree rotation, a further full rotation is performed and the welding filler material is fed in the upper weld seam space. Now, the laser beam strikes the welding filler material and thus produces a melt which fills the upper weld seam space and directly connects the upper weld seam surfaces in a positive-substance manner. After the completion of the second full rotation, the laser hybrid weld seam is also produced according to process step e).

In accordance with another further development, the method for producing a weld-coupled working cylinder assembly is characterized in that process step d) and process step e) are carried out simultaneously in parallel, that a relative movement of the pre-assembly is carried out along the weld seam and that the laser beam according to process step e) is offset with respect to the laser beam according to process step d) along the direction of the relative movement. This further development requires the use of two laser beams and enables a further improvement of their efficiency.

According to this further development, the method is carried out with two laser beams that are applied simultaneously but linearly offset along the feed motion. Along with the linear speed of the laser welding, the spatial offset makes it possible to precisely adjust the temporal offset of the laser application in the lower weld seam zone and in the upper weld seam zone at the same linear position of the weld seam and to optimize the weld formation. In particular, it is possible to keep the time offset sufficiently short for extremely large assemblies.

The invention is explained as an exemplary embodiment by means of the following figures. They show:

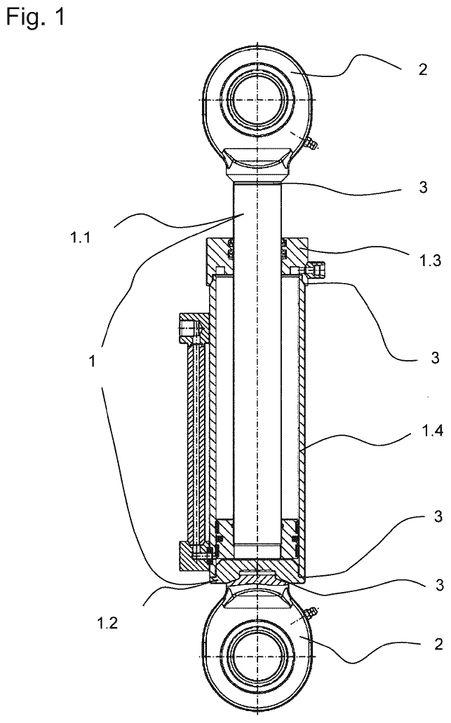

FIG. 1: General view of a working cylinder assembly as a cross-section,

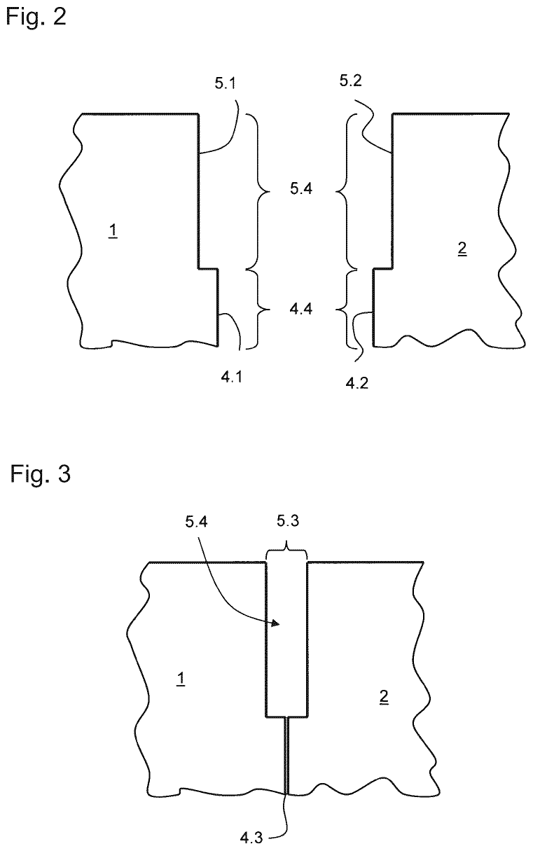

FIG. 2: Schematic cross-section of the area of the weld seam before joining to a pre-assembly,

FIG. 3: Schematic cross-section of the area of the weld seam in the condition of a pre-assembly,

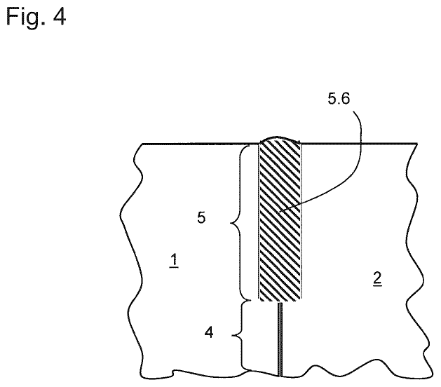

FIG. 4: Schematic cross-section of the weld seam,

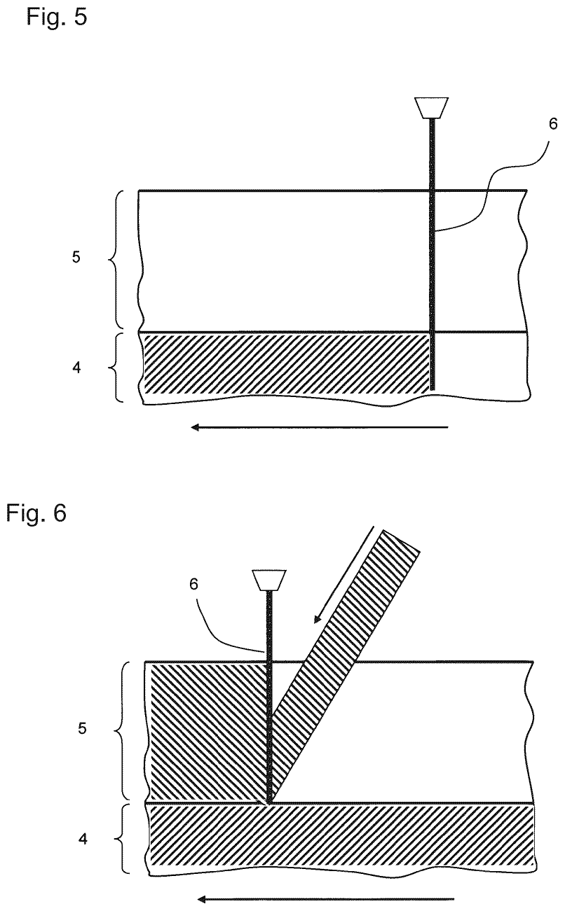

FIG. 5: Schematic representation of the method in process step d),

FIG. 6: Schematic representation of the method in process step e),

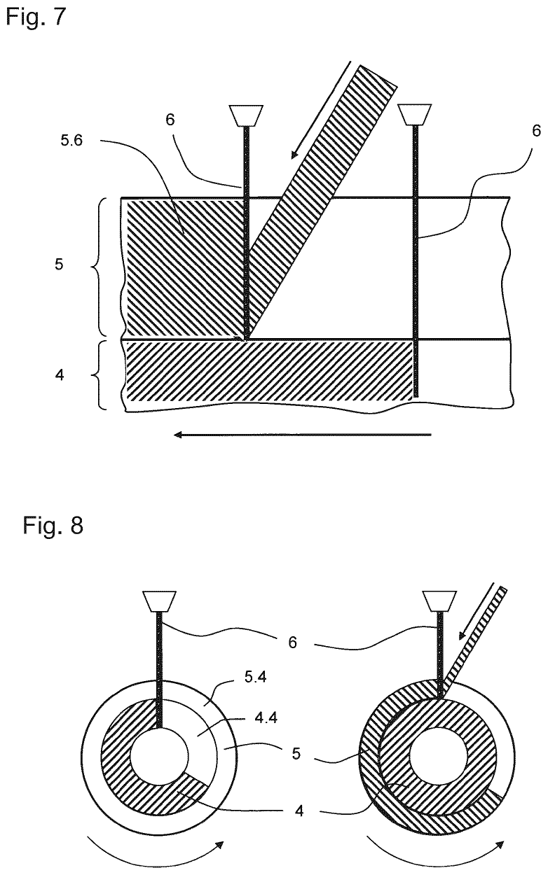

FIG. 7: Schematic representation of the method with parallel execution of process steps,

FIG. 8: Schematic representation of the method during the rotation of the pre- assembly.

In this context, the same reference numerals in the various figures always refer to the same features or components. The reference numerals are also used in the description even if they are not shown in the corresponding figure.

1 FIG. 1 shows a general view of the working cylinder assembly, which in the exemplary embodiment is a differential working cylinder. In this exemplary embodiment, the working cylinder component 1 is designed both as a piston rod 4 1.1 and as a closure part 1.2. Both the piston rod 1.1 and the closure part 1.2 are each connected to an attachment part 2, in this case a spherical bearing, by means of a weld seam 3.

FIG. 1 also shows that the cylinder tube 1.4 is designed as a working cylinder component 1, which is also connected on both sides to the closure part 1.2—in this case the bottom closure part—and the other closure part 1.3—in this case the guide closure part—by means of a weld seam 3. In this embodiment, the weld seam 3 between the cylinder tube 1.4 and the closure part 1.2—the bottom closure part—is vertical and the weld seam 3 between the cylinder tube 1.4 and the other closure part 1.3-here the guide closure part-is inclined at a weld angle.

FIG. 2 shows the coupling partners 1, 2 after process step b) and before joining to form the pre-assembly in process step c).

FIG. 3 shows the coupling partners 1, 2 after joining to form the pre-assembly in 18 process step c).

In the following, FIG. 2 and FIG. 3 are described together. In the later lower weld seam zone 4, the lower working cylinder component weld seam surface 4.1 and the lower attachment part weld seam surface 4.2 face each other as the lower weld seam surfaces 4.1, 4.2, and in the upper weld seam zone 5, the upper working cylinder component weld seam surface 5.1 and the upper attachment part weld seam surface 5.2 face each other as the upper weld seam surfaces 5.1, 5.2. The lower weld seam surfaces 4.1, 4.2 form the subsequent lower weld seam zone surface 4.4 and the upper weld seam surfaces 5.1, 5.2 form the later upper weld seam zone surface 5.4. After being joint in process step d), the lower weld seam surfaces 4.1, 4.2 form a butt joint and the upper weld seam surfaces 5.1, 5.2 form a surface separation 5.3. An upper weld seam space 5.4 is formed between the upper weld seam surfaces 5.1, 5.2 by the surface separation 5.3.

1 FIG. 4 shows the weld seam after welding when the process steps d) and e) have been carried out. The narrow laser weld seam is now provided in the lower weld seam zone 4. In the upper weld seam zone 5, the upper weld seam space 5.5 has a filling of welding filler material 5.6 now, which was provided by a welding wire melted by a laser beam 6. Now, both coupling partners are connected in a positive-substance manner by means of the laser weld seam of the lower weld seam zone 4 and the hybrid weld seam of the upper weld seam zone 5.

FIGS. 5 and 6 show the method with the process steps d) and e) being carried out in succession. 9

FIG. 5 shows process step d), in which the pre-assembly is guided under the laser beam 6 in the direction of movement indicated by the arrow. The laser beam 6 strikes the lower weld seam zone 4 directly, penetrates the butt joint 4.3 and welds the lower weld seam surfaces 4.1, 4.2. As FIG. 6 shows, the laser beam 6 is subsequently applied again to carry out process step e) and, for this purpose, the pre-assembly, which has already been fixed and preheated via the lower weld seam zone 4, is again guided in the direction of movement indicated by the arrow. At the same time, the welding filler material in the form of a welding wire is supplied and brought into the effective range of the laser beam 6 in the upper weld seam space 5.5, where it is melted to form a weld pool that fills the upper weld seam space 5.5 now. After solidification, the finished weld seam 3 consisting of the laser weld in the lower weld seam zone 4 and the laser hybrid weld seam in the upper weld seam zone 5 is provided.

FIG. 7 schematically shows the parallel execution of the process steps d) and e) in a modified exemplary embodiment. The direction of movement of the pre-assembly along the weld seam 3, which is shown here in a longitudinal section, is indicated by the arrow at the bottom. The laser beam 6 strikes the lower weld seam zone 4 directly, penetrates the butt joint 4.3 and welds the lower weld seam surfaces 4.1, 4.2.

The continued movement of the coupling partners 1, 2 causes them to enter the effective zone of a further laser beam 6. At the same time, the spatial distance generates, depending on the speed of movement, a time distance that is dimensioned such that heat is dissipated from the lower weld seam zone 4 to the upper weld seam zone 5, inter alia, so that the molten material begins to solidify in the laser weld seam in the lower weld seam zone 4 and preheating is caused in the upper weld seam zone 5. The further laser beam 6 captures the supplied welding wire in the upper weld seam space 5.5, melts it and simultaneously and indirectly covers the upper weld seam surfaces 5.1, 5.2 and melts them. The molten mass that forms in this way fills the weld seam space 5.5 where it acts as the welding filler material 5.6 in the upper weld seam zone 5. Thus, the laser hybrid weld is formed after solidification.

FIG. 8 is a schematic presentation of the method in an exemplary embodiment in which the lower weld seam zone 4 is formed as an inner ring surface and the upper weld seam zone 5 is formed as a concentric outer ring surface.

The left figure shows that, firstly in process step d), the lower weld seam zone 4 is generated as a laser weld seam by a first rotation of the laser beam 6 until, after an angular position of 360 degrees, this zone is a completely closed inner ring surface in a section longitudinal to the weld seam.

The left figure shows that, subsequently in process step e), the laser beam 6 generates the upper weld seam zone 5 as a laser hybrid weld seam by a further rotation and the addition of a welding wire until this zone also forms a completely closed outer ring surface after a full rotation.

FIG. 8 shows the two process steps, each after a rotation of about 240 degrees, with the arrows indicating the direction of rotation.

### LIST OF REFERENCE NUMERALS

1 Working cylinder component
1.1 Piston rod
1.2 Closure part
1.3 Further closure part
1.4 Cylinder tube
2 Attachment part
3 Weld seam
3.4 Total weld seam surface
4 Lower weld seam zone
4.1 Lower working cylinder component weld seam surface
4.2 Lower attachment part weld seam surface
4.3 Butt joint
4.4 Lower weld seam zone surface
5 Upper weld seam zone
5.1 Upper working cylinder component weld seam surface
5.2 Upper attachment part weld seam surface
5.3 Surface separation
5.4 Upper weld seam zone surface
5.5 Upper weld seam space
5.6 Filling of welding filler material
6 Laser

1-9 (canceled)

10. A weld-coupled working cylinder, comprising:
a working cylinder component being a piston rod or a closure part;
an attachment part being a coupling module for coupling to a device to be actuated for the transmission of force; and
a weld seam constructed as a step-wise produced hybrid weld seam having a lower weld seam zone and an upper weld seam zone;
in said lower weld seam zone, said working cylinder component having a lower working cylinder component weld seam surface and said attachment part having a lower attachment part weld seam surface, and said lower weld seam surfaces having a butt joint, and said lower weld seam zone being constructed as a laser weld seam;
in said upper weld seam zone said working cylinder component having an upper working cylinder component weld seam surface and said attachment part having an upper attachment part weld seam surface, said upper weld seam surfaces having a surface separation defining an upper weld seam space, said upper weld seam zone constructed as a laser hybrid weld seam having a filling of welding filler metal in said upper weld seam space.

11. The weld-coupled working cylinder assembly according to claim 10, wherein a lower weld seam zone surface and an upper weld seam zone surface form a total weld seam surface, and that the surface ratio of the lower weld seam zone surface to the total weld seam zone surface is 15% to 40%.

12. The weld-coupled working cylinder assembly according to claim 10, wherein the surface separation in the upper weld seam zone is 0.5 mm to 2.0 mm.

13. The weld-coupled working cylinder assembly according to claim 10, wherein the lower weld seam zone surface is formed as an inner circular surface or as a ring surface and said upper weld seam zone surface is an outer ring surface which radially encloses said lower weld seam zone surface.

14. A weld-coupled working cylinder assembly, comprising:
a working cylinder component being a cylinder tube;
an attachment part being a closure part or a further closure part; and
a weld seam constructed as a step-wise produced hybrid weld seam having a lower weld seam zone and an upper weld seam zone;
in said lower weld seam zone, said working cylinder component having a lower working cylinder component weld seam surface and said attachment part having a lower attachment part weld seam surface, said lower weld seam surfaces having a butt joint, and said lower weld seam zone being constructed as a laser weld seam;
in said upper weld seam zone, said working cylinder component having an upper working cylinder component weld seam surface and said attachment part having an upper attachment part weld seam surface, said upper weld seam surfaces having a surface separation defining an upper weld seam space, said upper weld seam zone being constructed as a laser hybrid weld seam having a filling of welding filler material in said upper weld seam space.

15. The weld-coupled working cylinder assembly according to claim 14, wherein a lower weld seam zone surface and an upper weld seam zone surface form a total weld seam surface, and that the surface ratio of the lower weld seam zone surface to the total weld seam zone surface is 15% to 40%.

16. The weld-coupled working cylinder assembly according to claim 14, wherein the surface separation in the upper weld seam zone is 0.5 mm to 2.0 mm.

17. The weld-coupled working cylinder assembly according to claim 14, wherein the lower weld seam zone surface is formed as an inner circular surface or as a ring surface and said upper weld seam zone surface is an outer ring surface which radially encloses said lower weld seam zone surface.

18. A method for producing a weld-coupled working cylinder assembly, comprising:
a) providing a working cylinder assembly including a working cylinder component and an attachment part;
b) producing a lower working cylinder component weld seam surface, a lower attachment part weld seam surface, an upper working cylinder component weld seam surface, and an upper attachment part weld seam surface, at least one of the upper weld seam surfaces is set back relative to a respective lower weld seam surface;
c) positioning the working cylinder component and the attachment part to define a pre-assembly by producing a butt joint of the lower weld seam surfaces and creating a surface separation of the upper weld seam surfaces;
d) laser welding the lower weld seam surfaces with a laser beam producing a laser weld seam in the lower weld seam zone; and
e) hybrid welding of the upper weld seam surfaces with the laser beam and supply of a welding filler material and filling of an upper weld seam space between the upper weld seam surfaces in the upper weld seam zone.

19. The method for producing a weld-coupled working cylinder assembly according to claim 18, wherein in process step d), an energy input per unit length in the lower weld seam zone is lower relative to a lower weld seam zone surface than an energy input per unit length in process step e) in the upper weld seam zone relative to an upper weld seam zone surface.

20. The method for producing a weld-coupled working cylinder assembly according to claim 19, wherein the lower weld seam zone surface is constructed as an inner circular surface or as an inner ring surface, and that the upper weld seam zone surface is constructed as an outer ring surface which radially encloses the lower weld seam zone surface;
in process step d), a movement of the pre-assembly relative to the laser beam is carried out by a rotation of the pre-assembly; and
in process step e), a movement of the pre-assembly relative to the laser is carried out by a further rotation of the pre-assembly.

21. The process for producing a weld-coupled working cylinder assembly according to claim 20, wherein the process step d) and the process step e) are carried out in parallel and a relative movement of the pre-assembly is carried out along the weld seam, and that the laser beam according to the process step e) is offset relative to the laser beam according to the process step d) along the direction of the relative movement.
